(19) United States
(12) Patent Application Publication
(10) Pub. No.: US 2004/0142213 A1
(43) Pub. Date: Jul. 22, 2004

(54) Decorative and protective coating

(76) Inventors: Guocun Chen, Broomfield, CO (US); Patrick B. Jonte, Zionsville, IN (US)

Correspondence Address: EMCH, SCHAFFER, SCHAUB, & PORCELLO CO., L.P.A., P.O. BOX 916, TOLEDO, OH, 43697-0916, US

(21) Appl. No.: 10/347,962

(22) Filed: Jan. 21, 2003

(51) Int. Cl. B32B 9/00; B32B 19/00

(52) U.S. Cl. 428/701

(57) ABSTRACT

An article is coated with a decorative and protective multi-layer coating. The coating comprises a nickel basecoat layer on the surface of said article, a chromium strengthening layer on said basecoat layer, an intermediate oxide layer on said strengthening layer, a stack layer comprised of layers of chromium compound, refractory metal compound or refractory metal alloy compound alternating with layers of chromium, refractory metal or refractory metal alloy on said intermediate oxide layer, a decorative and protective layer comprised of chromium compound, refractory metal compound or a refractory metal alloy compound on said stack layer, and a top oxide layer on said decorative and protective layer. The intermediate oxide layer acts as a non-conductive barrier layer to improve corrosion and pitting resistance.

### FIELD OF THE INVENTION

This invention relates to articles having a multi-layered decorative and protective coating thereon.

### BACKGROUND OF THE INVENTION

It is currently the practice with various brass articles such as lamps trivets, candlesticks, door knobs and handles and the like to first buff and polish the surface of the article to a high gloss and to then apply a protective organic coating, such as one comprised of acrylics, urethanes, epoxies, and the like, onto this polished surface. While this system is generally quite satisfactory it has the drawback that the buffing and polishing operation, particularly if the article is of a complex shape, is labor intensive. Also, the known organic coatings are not always as durable as desired, particularly in outdoor applications where the articles are exposed to the elements and ultraviolet radiation.

The problems with organic coatings have been overcome by the application of physical vapor deposited coatings. However, even with these coatings there is a problem with corrosion and pitting after an extended period of use in an aggressive environment, such as tropical coastal areas. The present invention provides vapor deposited coatings which have improved corrosion resistance and reduced pitting.

### SUMMARY OF THE INVENTION

The present invention is directed, to an article, such as a plastic, ceramic or metallic article, having a multi-layer coating on at least a portion of its surface. More particularly, it is directed to an article or substrate, particularly a metallic article such as stainless steel, aluminum, brass or zinc, having deposited in at least a portion of its surface a coating comprised of multiple superposed layers of certain specific types of materials. The coating is decorative and also provides corrosion resistance, wear resistance, improved chemical resistance, and is smooth.

The article has deposited on its surface a nickel basecoat layer. The nickel basecoat layer functions to level the surface of the article, cover any scratches or imperfections in the surface of the article, provide a smooth and even surface for the deposition of the subsequent layers of the multi-layered coatings, and provide improved corrosion resistance.

In one embodiment over the nickel basecoat layer is applied a strengthening layer comprised of a metal, such as chromium, or metal alloy, such as tin-nickel alloy. Over this strengthening layer is applied a chromium, refractory metal or refractory metal alloy strike layer. Over this strike layer is applied an intermediate oxide layer comprised of chromium oxide, refractory metal oxide or refractory metal alloy oxide. Over this intermediate oxide layer is applied a stack layer comprised of layers of chromium compound, refractory metal compound or refractory metal alloy compound alternating with layers comprised of chromium, refractory metal or refractory metal alloy. Over the stack layer is applied a protective color layer comprised of a chromium compound, refractory metal compound or refractory metal alloy compound such as a nitride, oxy-nitride, carbide or carbonitride. Over the color layer is a thin top oxide layer comprised of chromium oxide, refractory metal oxide or refractory metal alloy oxide.

### BRIEF DESCRIPTION OF THE DRAWINGS

FIG. 1 is a cross-sectional view, not to scale, of the coated article of the instant invention wherein the coating comprises a nickel basecoat layer, a strike layer, an intermediate oxide layer, a stack layer comprised of alternating layers of a refractory metal and a refractory metal nitride layer, a color layer and a top oxide layer; and

FIG. 2 is similar to FIG. 1 except that a strengthening layer is present intermediate the nickel layer and the strike layer.

### DESCRIPTION OF THE PREFERRED EMBODIMENT

The substrate 12 can be any plastic, ceramic, cermet, metal or metallic alloy. Illustrative of metal and metal alloy substrates are copper, steel, brass, tungsten, nickel alloys and the like. In one embodiment the substrate is brass.

A nickel layer 13 is deposited on the surface of the substrate 12 by conventional and well known electroplating processes. These processes include using a conventional electroplating bath such as, for example, a Watts bath as the plating solution. Typically such baths contain nickel sulfate, nickel chloride and boric acid dissolved in water. All chloride, sulfamate, and fluoroborate plating solutions can also be used. These baths can optionally include a number of well known and conventionally used compounds such as leveling agents, brighteners, and the like. To produce specularly bright nickel layer at least one brightener from class I and at least one brightener from class II is added to the plating solution. Class I brighteners are organic compounds which contain sulfur.

Class II brighteners are organic compounds which do not contain sulfur. Class II brighteners can also cause leveling and, when added to the plating bath without the sulfur-containing class I brighteners, result in semi-bright nickel deposits. These class I brighteners include alkyl naphthalene and benzene sulfonic acid. The benzene and naphthalene di- and trisulfonic acids, benzene and naphthalene sulfonamides, and sulfonamides such as saccharin, vinyl and allyl sulfonamides and sulfonic acids. The class II brighteners generally are unsaturated organic materials such as, for example, acetylenic or ethylenic alcohols, ethoxylated and propoxylated acetylenic alcohols, coumarins, and aldehydes. These class I and class II brighteners are well known to those skilled in the art and are readily commercially available. They are described, inter alia, in U.S. Pat. No. 4,421,611 incorporated herein by reference.

The nickel layer 13 can be comprised of a single nickel layer such as, for example, bright nickel, or it can be comprised of two different nickel layers such as, for example, a semi-bright nickel layer and a bright nickel layer. In the figures layer 14 is comprised of semi-bright nickel while layer 16 is comprised of bright nickel. This duplex nickel deposit provides improved corrosion protection to the underlying substrate and provides leveling. The semi-bright, sulfur free plate 14 is deposited by conventional electroplating processes directly on the surface of substrate 12. The substrate 12 containing the semi-bright nickel layer 14 is then plated in a bright nickel plating bath and the bright nickel layer 16 is deposited on the semi-bright nickel layer 14, also by conventional electroplating processes.

The thickness of the nickel layer 13 is generally a thickness which is (i) effective to provide improved corrosion protection to the substrate, and (ii) provide leveling of the substrate. This thickness is generally in the range of from at least about 2.5 μm, preferably from at least about 4 μm to about 90 μm.

In the embodiment where a duplex nickel layer is used, the thickness of the semi-bright nickel layer and the bright nickel layer is a thickness effective to provide improved corrosion protection. Generally, the thickness of the semi-bright nickel layer 14 is at least about 0.1 μm, preferably at least about 2.5 μm, and more preferably at least about 3.5 μm. The upper thickness limit is generally not critical and is governed by secondary considerations such as cost and appearance. Generally, however, a thickness of about 50 μm, preferably about 30 μm, and more preferably 20 μm should not be exceeded. The bright nickel layer 16 generally has a thickness of at least about 1 μm, preferably at least about 3 μm, and more preferably at least about 6 μm. The upper thickness range of the bright nickel layer is not critical and is generally controlled by considerations such as cost. Generally, however, a thickness of about 60 μm, preferably about 50 μm, and more preferably about 40 μm should not be exceeded. The bright nickel layer 16, in particular, also functions as a leveling layer which tends to cover or fill in surface imperfections in the substrate.

In one embodiment, as illustrated in FIG. 2, deposited over nickel layer 13, particularly the bright nickel layer is a strengthening layer 22 comprised of chromium. The strengthening chromium layer 22 may be deposited on layer 13 by plating or vapor deposition such as physical vapor deposition. Plating includes electroplating. The chromium electroplating techniques along with various chromium plating baths are well known and conventional and are disclosed, inter alia, in Brassard, “Decorative Electroplating—A Process in Transition”, Metal Finishing, pp. 105-108, June 1988; Zaki, “Chromium Plating”, PF Directory, pp. 146-160; and in U.S. Pat. Nos. 4,460,438; 4,234,396 and 4,093,522, all of which are incorporated herein by reference.

Chromium plating baths are well known and commercially available. A typical chromium plating bath contains chromic acid or sales thereof, and catalyst ion such as sulfate or fluoride. The catalyst ions can be provided by sulfuric acid or its salts and fluosilicic acid. The baths may be operated at a temperature of about 112°-116° F. Typically in chrome plating a current density of about 150 amps per square foot, at about 5 to 9 volts is utilized.

The chromium strengthening layer 22 serves to provide structural integrity of the coating and/or reduce or eliminate plastic deformation of the coating. The nickel layer 13 is relatively soft compared to the refractory metal compound color layer 36. Thus, an object impinging on, striking or pressing on layer 36 will not penetrate this relatively hard layer, but this force will be transferred to the relatively soft underlying nickel layer 13 causing plastic deformation of this layer. Chromium strengthening layer 22, being relatively harder than the nickel layer, will generally resist the plastic deformation that the nickel layer 13 undergoes.

Chromium layer 22 has a thickness at least effective to provide structural integrity to and reduce plastic deformation of the coating. This thickness is at least about 0.05 μm, preferably at least about 0.1 μm, and more preferably at least about 0.2 μm. Generally, the upper range of thickness is not critical and is determined by secondary considerations such as cost. However, the thickness of the chrome layer should generally not exceed about 5 μm, preferably about 2 μm, and more preferably about 1 μm.

Instead of layer 22 being comprised of chromium it may be comprised of tin-nickel alloy, palladium-nickel alloy or nickel-tungsten-boron alloy.

The tin-nickel layer may be deposited by plating such as electroplating or vapor deposition such as physical vapor deposition. If the tin-nickel layer is deposited by electroplating it is deposited by conventional and well known tin-nickel electroplating processes. These processes and plating baths are described, inter alia, in U.S. Pat. Nos. 4,033,835; 4,049,508; 3,887,444; 3,772,168 and 3,940,319, all of which are incorporated herein by reference.

The tin-nickel alloy layer is preferably comprised of about 60-70 weight percent tin and about 30-40 weight percent nickel, more preferably about 65% tin and 35% nickel representing the atomic composition SnNi. The plating bath contains sufficient amounts of nickel and tin to provide a tin-nickel alloy of the afore-described composition.

A commercially available tin-nickel plating process is the Ni-Colloy™ process available from ATOTECH, and described in their Technical Information Sheet No: NiColloy, Oct. 30, 1994, incorporated herein by reference.

The nickel-tungsten-boron alloy layer may be deposited by plating such as electroplating or vapor deposition such as physical vapor deposition. If the nickel-tungsten-boron alloy layer is deposited by electroplating, it is deposited by conventional and well known nickel-tungsten-boron electroplating processes. The plating bath is normally operated at a temperature of about 115° to 125° F. and a preferred pH range of about 8.2 to about 8.6. The well known soluble, preferably water soluble, salts of nickel, tungsten and boron are utilized in the plating bath or solution to provide concentrations of nickel, tungsten and boron.

The amorphous nickel-tungsten-boron alloy layer generally contains at least 50, preferably at least about 55, and more preferably at least 57.5 weight percent nickel, at least about 30, preferably at least about 35, and more preferably at least 37.5 weight percent tungsten, and at least about 0.05, preferably at least about 0.5, and more preferably at least about 0.75 weight percent boron. Generally the amount of nickel does not exceed about 70, preferably about 65, and more preferably about 62.5 weight percent, the amount of tungsten does not exceed about 50, preferably about 45, and more preferably about 42.5 weight percent, and the amount of boron does not exceed about 2.5, preferably about 2, and more preferably about 1.25 weight percent. The plating bath contains sufficient amounts of the salts, preferably soluble salts, of nickel, tungsten and boron to provide a nickel-tungsten-boron alloy of the afore-described composition.

A nickel-tungsten-boron plating bath effective to provide a nickel-tungsten-boron alloy of which a composition is commercially available, such as the Amplate™ system from Amorphous Technologies International of Laguna Niguel, California. A typical nickel-tungsten-boron alloy contains about 59.5 weight percent nickel, about 39.5 weight percent tungsten, and about 1% boron. The nickel-tungsten-boron alloy is an amorphous/nano-crystalline composite alloy. Such an alloy layer is deposited by the AMPLATE plating process marketed by Amorphous Technologies International.

The palladium-nickel alloy layer may be deposited by plating such as electroplating or vapor deposition such as physical vapor deposition. If the palladium-nickel alloy layer is deposited by electroplating, it is deposited by conventional and well known palladium-nickel electroplating process. Generally, they include the use of palladium salts or complexes such as nickel amine sulfate, organic brighteners, and the like. Some illustrative examples of palladium/nickel electroplating processes and baths are described in U.S. Pat. Nos. 4,849,303; 4,463,660; 4,416,748; 4,428,820 and 4,699,697, all of which are incorporated by reference.

The weight ratio of palladium to nickel in the palladium/nickel alloy is dependent, inter alia, on the concentration of palladium (in the form of its salt) in the plating bath. The higher the palladium salt concentration or ratio relative to the nickel salt concentration in the bath the higher the palladium ratio in the palladium/nickel alloy.

The palladium/nickel alloy layer generally has a weight ratio of palladium to nickel of from about 50:50 to about 95:5, preferably from about 60:40 to about 90:10, and more preferably from about 70:30 to about 85:15.

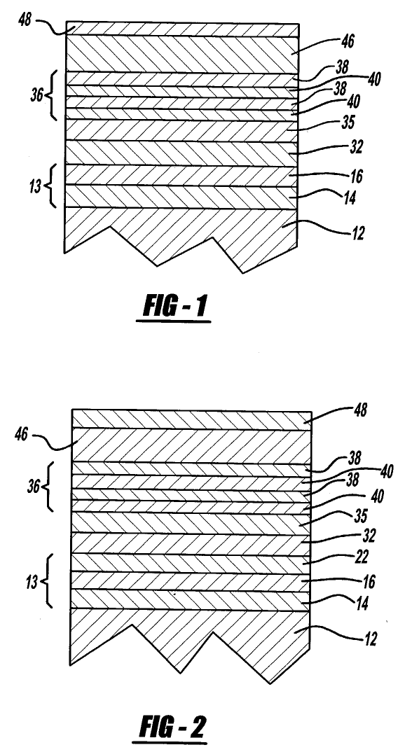

Preferably, layer 22 is comprised of chromium. Over layer 22, if present as illustrated in the embodiment of FIG. 2, otherwise over nickel layer 13 in the embodiment where layer 22 is not present as illustrated in FIG. 1, is disposed strike layer 32 comprised of chromium, a refractory metal or a refractory metal alloy such as hafnium, tantalum, zirconium, titanium or zirconium-titanium alloy, preferably zirconium, titanium or zirconium-titanium alloy, and more preferably zirconium or titanium.

Layer 32 is deposited by conventional and well known techniques including electrodeposition and vapor deposition techniques such as cathodic arc evaporation (CAE) or sputtering, and the like. Sputtering and CAF techniques and equipment are disclosed, inter alia, in J. Vossen and W. Kern “Thin Film Processes II”, Academic Press, 1991; R. Boxman et al, “Handbook of Vacuum Arc Science and Technology”, Noyes Pub., 1995; and U.S. Pat. Nos. 4,162,954 and 4,591,418, all of which are incorporated herein by reference.

Briefly, in the sputtering deposition process a chrome or refractory metal (such as titanium or zirconium) target, which is the cathode, and the substrate are placed in a vacuum chamber. The air in the chamber is evacuated to produce vacuum conditions in the chamber. An inert gas, such as Argon, is introduced into the chamber. The gas particles are ionized and are accelerated to the target to dislodge titanium or zirconium atoms. The dislodged target material is then typically deposited as a coating film on the substrate.

In cathodic arc evaporation, an electric arc of typically several hundred amperes is struck on the surface of a metal cathode such as zirconium or titanium. The arc vaporizes the cathode material, which then condenses on the substrates forming a coating.

Layer 32 has a thickness which is generally at least effective to function as a strike layer and improve the adhesion of the stack layer 36 and color layer 46 to the underlying layer(s). This thickness is generally at least about 50 Å, preferably at least about 120 Å, and more preferably at least about 250 Å. The upper thickness range is not critical and is generally dependent upon secondary considerations such as cost. Generally, however, layer 32 should not be thicker than about 1.5 μm, preferably about 0.5 μm, and more preferably about 0.25 μm.

In a preferred embodiment of the present invention layer 32 is comprised of titanium, zirconium or zirconium-titanium alloy, preferably zirconium or zirconium-titanium alloy, and is deposited by sputtering or cathodic arc evaporation.

In the embodiment where strengthening layer 22 is chromium, strike layer 32 is absent and strengthening layer 22 acts as a strike layer.

Over strike layer 32, or strengthening layer 22 when strike layer 32 is absent, is intermediate oxide layer 35. Intermediate oxide layer 35 is comprised of chromium oxide, refractory metal oxide or refractory metal alloy oxide. Intermediate oxide layer 35 functions, inter alia, to improve corrosion resistance, reduce pitting, and acts as a non-conductive barrier layer free of macroparticles.

The thickness of the intermediate oxide layer 35 is a thickness effective to improve corrosion resistance, reduce pitting, and act as a non-conductive barrier layer free of macroparticles. This thickness if from about 50 Å to about 800 Å, preferably from about 100 Å to about 300 Å. If the oxide layer is thinner than about 50 Å there is little, if any, barrier effect or improvement in corrosion resistance and reduction of pitting.

Preferably intermediate oxide layer 35 contains a stoichiometric amount of oxygen. It is to be understood that intermediate oxide layer 35 can in general, contain a substoichiometric amount of oxygen, e.g., 2-50 atomic percent. Over intermediate oxide layer 35 is deposited stack layer 36. Stack layer 36 is comprised of layers 38 of chromium compound, refractory metal compound or refractory metal compound alternating with layers 40 of chromium, refractory metal or refractory metal alloy. The chromium compound, refractory metal compound and refractory metal alloy compound are the nitrides, carbides and carbonitrides, e.g. chromium nitride, chromium carbides, zirconium carbonitride, titanium nitride and zirconium-titanium alloy carbonitride.

The stack layer 36 generally has an average thickness of from about 1,000 Å to about 1 μm, preferably from about 0.1 μm to about 0.9 μm, and more preferably from about 0.15 μm to 0.75 μm. The stack layer generally contains from about 2 to about 100 alternating layers 28 and 30, preferably from about 4 to about 50 alternating layers 28 and 30.

Each of the layers 38 and 40 generally has a thickness of at least about 25 Å, preferably at least about 50 Å, and more preferably at least about 100 Å. Generally, layers 38 and 40 should not be thicker than about 0.38 μm, preferably about 0.25 μm, and more preferably abut 0.1 μm.

A method of forming the stack layer 36 is by utilizing sputtering or cathodic arc evaporation to deposit a layer 38 of refractory metal such as zirconium or titanium followed by reactive sputtering or reactive cathodic arc evaporation to deposit a layer 40 of, e.g., refractory metal nitrogen containing compound such as zirconium nitride or titanium nitride.

Reactive physical vapor deposition such as reactive cathodic arc evaporation and reactive sputtering are generally similar to ordinary sputtering and cathodic arc evaporation except that a reactive gas is introduced into the chamber which reacts with the dislodged target material. Thus, in the case where zirconium nitride is layer 40, the cathode is comprised of zirconium, and nitrogen is the reactive gas introduced into the chamber.

Preferably the flow rate of reactive gas such as nitrogen gas is varied (pulsed) during vapor deposition such as reactive sputtering between zero (no reactive gas is introduced) to the introduction of gas at a desired value to form multiple alternating layers of metal 38 and metal nitrogen containing compound 40 in the stack layer 36.

It is important that the top layer of stack 36 be chromium, refractory metal or refractory metal alloy, i.e., layer 38. This top stack layer 38 functions, in effect, as a strike layer. It should thus be at least thick enough to function as a strike layer. This thickness is generally at least about 50 Å, preferably at least about 120 Å, and more preferably at least about 250 Å. The upper thickness range is not critical and is generally dependent upon secondary considerations such as cost. Generally, however, layer 38 should not be thicker than about 1.5 μm, preferably about 0.5 μm, and more preferably about 0.25 μm.

Over stack layer 36 is deposited, by reactive vapor deposition such as reactive physical vapor deposition, a protective and decorative color layer 46 comprised of a chromium compound, refractory metal compound or refractory metal alloy compound. The chromium compounds, refractory metal compound and refractory metal alloy compounds include the nitrides, carbides and carbonitrides.

Some illustrative, non-limiting examples of these compounds include chromium nitride, chromium carbide, zirconium carbonitride, titanium nitride, hafnium carbide, zirconium-titanium alloy carbide, zirconium nitride and titanium carbonitride.

Layer 46 provides wear and abrasion resistance and the desired color or appearance. Layer 46 is deposited on stack layer 36 by any of the well known and conventional vapor deposition techniques, for example physical vapor deposition techniques such as reactive sputtering and cathodic arc evaporation.

Layer 46 has a thickness at least effective to provide wear and abrasion resistance and the desired color or appearance. Generally, this thickness is at least about 1,000 Å, and more preferably at least about 2,500 Å. The upper thickness range is generally not critical and is dependent upon secondary considerations such as cost. Generally a thickness of about 1 μm, and preferably about 0.5 μm should not be exceeded.

Over color layer 46 is an oxide top layer 48. Oxide top layer 48 is comprised of chromium oxide, refractory metal oxide or refractory metal alloy oxide. The refractory metal oxides and refractory metal alloy oxides of which layer 48 is comprised include, but are not limited to, hafnium oxide, tantalum oxide, zirconium oxide, titanium oxide, and zirconium-titanium alloy oxide.

Layer 48 generally provides improved chemical resistance and is necessary for intermediate oxide layer 35 to function effectively. If top oxide layer 48 is absent, intermediate oxide layer 44 will not provide sufficiently improved corrosion and pitting resistance. Top oxide layer 48 is generally thin enough to be transparent or translucent so that the color of color layer 46 can be seen through layer 48, but thick enough to provide improved chemical resistance. Generally, this thickness is at least about 1 nm, preferably at least about 5 nm. The thickness should generally not be greater than about 50 nm, preferably not greater than about 25 nm in order to avoid changing the color of color layer 46 or producing interference reflections.

In order that the invention may be more readily understood the following example is provided. The example is illustrative and does not limit the invention thereto.

### EXAMPLE

Brass door handles are placed in a conventional soak cleaner bath containing the standard and well known soaps, detergents, defloculants and the like which is maintained at a pH of 8.9-9.2 and a temperature of 180-200° F. for about 10 minutes. The brass door handles are then placed in a conventional ultrasonic alkaline cleaner bath. The ultrasonic cleaner bath has a pH of 8.9-9.2, is maintained at a temperature of about 160-180° F., and contains the conventional and well known soaps, detergents, defloculants and the like. After the ultrasonic cleaning the door handles are rinsed and placed in a conventional alkaline electro cleaner bath. The electro cleaner bath is maintained at a temperature of about 140-180° F., a pH of about 10.5-11.5, and contains standard and conventional detergents. The door handles are then rinsed twice and placed in a conventional acid activator bath. The acid activator bath has a pH of about 2.0-3.0, is at an ambient temperature, and contains a sodium fluoride based acid salt. The door handles are then rinsed twice and placed in a bright nickel plating bath for about 12 minutes. The bright nickel bath is generally a conventional bath which is maintained at a temperature of about 130-150° F., a pH of about 4.0, contains NiSO₄, NiCl₂, boric acid, and brighteners. A bright nickel layer of an average thickness of about 10 μm is deposited on the faucet surface. The bright nickel plated door handles are rinsed three times and then placed in a conventional, commercially available hexavalent chromium plating bath using conventional chromium plating equipment for about seven minutes.

The hexavalent chromium bath is a conventional and well known bath which contains about 32 ounces/gallon of chromic acid. The bath also contains the conventional and well known chromium plating additives. The bath is maintained at a temperature of about 112-116° F., and utilizes a mixed sulfate/fluoride catalyst. The chromic acid to sulfate ratio is about 200:1. A Chromium layer of about 0.25 μm is deposited on the surface of the bright nickel layer. The door handles are thoroughly rinsed in deionized water and then dried.

The chromium plated door handles are placed in a cathodic arc evaporation plating vessel. The vessel is generally a cylindrical enclosure containing a vacuum chamber which is adapted to be evacuated by means of pumps. A source of argon gas is connected to the chamber by an adjustable valve for varying the rate of flow of argon into the chamber. In addition, sources of nitrogen and oxygen gases are connected to the chamber by adjustable valves for varying the flow rates of nitrogen and oxygen into the chamber.

A cylindrical cathode is mounted in the center of the chamber and connected to negative outputs of a variable D.C. power supply. The positive side of the power supply is connected to the chamber wall. The cathode material comprises zirconium.

The plated door handles are mounted on spindles, 16 of which are mounted on a ring around the outside of the cathode. The entire ring rotates around the cathode while each spindle also rotates around its own axis, resulting in a so-called planetary motion which provides uniform exposure to the cathode for the multiple door handles mounted around each spindle. The ring typically rotates at several rpm, while each spindle makes several revolutions per ring revolution. The spindles are electrically isolated from the chamber and provided with rotatable contacts so that a bias voltage may be applied to the substrates during coating.

The vacuum chamber is evacuated to a pressure of about 10⁻⁵ to 10⁻⁷ torr and heated to about 150° C.

The electroplated door handles are then subjected to a high-bias arc plasma cleaning in which a (negative) bias voltage of down to −600 volts is applied to the electroplated door handles while an arc of approximately 500 amperes is struck and sustained on the cathode. The duration of the cleaning is approximately five minutes.

Argon gas is introduced at a rate sufficient to maintain a pressure of about 1 to 5 millitorr. A layer of zirconium having an average thickness of about 0.1 μm is deposited on the chrome plated door handles during a three minute period. The cathodic arc deposition process comprises applying D.C. power to the cathode to achieve a current flow of about 500 amps, introducing argon gas into the vessel to maintain the pressure in the vessel at about 1 to 5 millitorr and rotating the door handles in a planetary fashion described above.

After the zirconium layer is deposited, a non-conductive zirconium oxide barrier layer is deposited on the zirconium metal layer. A flow of oxygen is introduced into the vacuum chamber while the arc discharge is maintained at a designated current value for 5 minutes. The flow ratio of oxygen to argon should be maintained such that a stable arc plasma is maintained while no charging builds up on the target surface that prevents further formation of plasma, and a stoichiometric zirconium oxide barrier layer is deposited. Normally, this zirconium oxide layer is preferably between 100 Å to 300 Å thick to act as an efficient non-conductive barrier layer to improve corrosion and pitting resistance.

On the top zirconium oxide layer, a stack of alternating layers of a zirconium metal and substoichiometric zirconium nitride layer and a stoichiometric zirconium nitride layer is deposited. A flow of nitrogen is introduced into the chamber and varied such that a thin layer of zirconium metal and substoichiometric zirconium nitride layer is produced when the nitrogen flow is decreased and a thin layer of stoichiometric zirconium nitride is produced when the nitrogen flow is sufficient.

On the stack layers of alternative mixture of zirconium metal and substoichiometric zirconium nitride layer and stoichiometric layer, a zirconium nitride, substoichiometric nitride or oxy-nitride color is deposited. A flow of nitrogen or nitrogen and oxygen is introduced into the vacuum chamber while the arc discharge continues at approximately 500 amperes. In production of a brass color zirconium nitride, the flow of nitrogen is a flow which will produce zirconium nitride layer having nitrogen content of about 35 to 50 atomic percent. In production of nickel or stainless steel color, substoichiometric zirconium nitride or zirconium oxy-nitride when flow of nitrogen and oxygen results in total nitrogen and oxygen content of 14 to 35 atomic percent in the zirconium nitride and oxide layer. The zirconium nitride or nitride and oxide color layer having a thickness of about 1,500 Å to 7,500 Å.

While certain embodiments of the invention have been described for purposes of illustration, it is to be understood that there may be various embodiments and modifications within the general scope of the invention.

We claim:

1. An article having on at least a portion of its surface a decorative and protective multi-layer coating comprising:
basecoat layer comprised of nickel;
intermediate oxide layer comprised of chromium oxide, refractory metal oxide or refractory metal alloy oxide;
stack layer comprised of layers comprised of chromium compound, refractory metal compound or refractory metal alloy compound alternating with layers comprised of chromium, refractory metal or refractory metal alloy wherein the top layer of said stack layer is a strike layer comprised of chromium, refractory metal or refractory metal alloy;
color layer comprised of chromium compound, refractory metal compound or refractory metal alloy compound; and
top oxide layer comprised of chromium oxide, refractory metal oxide or refractory metal alloy oxide.

2. The article of claim 1 wherein a strengthening layer comprised of chromium or metal alloy is intermediate said basecoat layer and said intermediate oxide layer.

3. The article of claim 1 wherein said intermediate oxide layer has a thickness at least effective to improve corrosion resistance, reduce pitting, and function as a non-conductive barrier layer free of macroparticles.

4. The article of claim 3 wherein said thickness is from about 50 Å to about 800 Å.

5. The article of claim 3 wherein said top oxide layer has a thickness at least effective to provide improved chemical resistance.

6. The article of claim 1 wherein the chromium compounds, refractory metal compounds or refractory metal alloy compounds are selected from the group consisting of the nitrides, carbides, carbonitrides, oxides and oxy-nitrides.

7. The article of claim 6 wherein said compounds are selected from the group consisting of nitrides, carbides and carbonitrides.

8. An article having on at least a portion of its surface a decorative and protective multi-layer coating comprising:
basecoat layer comprised of semi-bright nickel;
basecoat layer comprised of bright nickel;
intermediate oxide layer comprised of chromium oxide, refractory metal oxide or refractory metal alloy oxide;
stack layer comprised of layers comprised of chromium compound, refractory metal compound or refractory metal alloy compound alternating with layers comprised of chromium, refractory metal or refractory metal alloy wherein the top layer of said stack layer is a strike layer comprised of chromium, refractory metal or refractory metal alloy;
color layer comprised of chromium compound, refractory metal compound or refractory metal alloy compound; and
top oxide layer comprised of chromium oxide, refractory metal oxide or refractory metal alloy oxide.

9. The article of claim 8 wherein a strengthening layer comprised of chromium or metal alloy is intermediate said basecoat bright nickel layer and said intermediate oxide layer.

10. The article of claim 8 wherein said intermediate oxide layer has a thickness at least effective to improve corrosion resistance, reduce pitting, and function as a non-conductive barrier layer free of macroparticles.

11. The article of claim 10 wherein said thickness is from about 50 Å to about 800 Å.

12. The article of claim 9 wherein said top oxide layer has a thickness at least effective to provide improved chemical resistance.

13. The article of claim 8 wherein said chromium compounds, refractory metal compounds or refractory metal alloy compounds are selected from the group consisting of the nitrides, carbides, carbonitrides, oxides and oxy-nitrides.

14. The article of claim 13 wherein said compounds are selected from the nitrides, carbides and carbonitrides.
